(19) United States
(12) Patent Application Publication
(10) Pub. No.: US 2015/0212752 A1
(43) Pub. Date: Jul. 30, 2015

(54) STORAGE SYSTEM REDUNDANT ARRAY OF SOLID STATE DISK ARRAY

(71) Applicant: Avalanche Technology, Inc., Fremont, CA (US)

(72) Inventors: Siamack Nemazie, Los Altos Hills, CA (US); Mehdi Asnaashari, Danville, CA (US); Ruchirkumar D. Shah, San Jose, CA (US)

(21) Appl. No.: 14/678,777

(22) Filed: Apr. 3, 2015

Related U.S. Application Data
(63) Continuation-in-part of application No. 14/073,669, filed on Nov. 6, 2013, now Pat. No. 9,009,397.
Application No. 14/073,669 is a continuation-in-part of application No. 14/629,404, filed on Feb. 23, 2015.
Application No. 14/629,404 is a continuation-in-part of application No. 14/595,170, filed on Jan. 12, 2015.
Application No. 14/595,170 is a continuation-in-part of application No. 13/858,875, filed on Apr. 8, 2013.

(51) Int. Cl. G06F 3/06

(52) U.S. Cl. CPC G06F 3/0619; G06F 3/064; G06F 3/0688

(57) ABSTRACT

A storage system includes a storage processor coupled to solid state disks (SSDs) and a host, the SSDs are identified by SSD logical block addresses (SLBAs). The storage processor receives a command from the host to write data to the SSDs and further receives a location within the SSDs to write the data, the location being referred to as a host LBA. The storage processor includes a central processor unit (CPU) subsystem and maintains unassigned SLBAs of a corresponding SSD. The CPU subsystem upon receiving the command to write data, generates sub-commands based on a range of host LBAs derived from the received command and further based on a granularity. At least one of the host LBAs is non-sequential relative to the remaining host LBAs. The CPU subsystem assigns the sub-commands to unassigned SLBAs by assigning each sub-command to a distinct SSD of a stripe, the host LBAs being decoupled from the SLBAs. The CPU subsystem continues to assign the sub-commands until all remaining SLBAs of the stripe are assigned, after which it calculates parity for the stripe and saves the calculated parity to one or more of the SSDs of the stripe.

### CROSS REFERENCE TO RELATED APPLICATIONS

This application is a continuation in part of U.S. patent application Ser. No. 14/073,669, filed on Nov. 6, 2013, by Mehdi Asnaashari, and entitled “STORAGE PROCESSOR MANAGING SOLID STATE DISK ARRAY”, and a continuation in part of U.S. patent application Ser. No. 14/629,404, filed on Feb. 23, 2015, by Mehdi Asnaashari, and entitled “STORAGE PROCESSOR MANAGING NVME LOGICALLY ADDRESSED SOLID STATE DISK ARRAY”, and a continuation in part of U.S. patent application Ser. No. 14/595,170, filed on Jan. 12, 2015, by Mehdi Asnaashari, and entitled “STORAGE PROCESSOR MANAGING SOLID STATE DISK ARRAY”, and a continuation in part of U.S. patent application Ser. No. 13/858,875, filed on Apr. 8, 2013, by Siamack Nemazie, and entitled “Storage System Employing MRAM and Redundant Array of Solid State Disk”

### BACKGROUND

Achieving high and/or consistent performance in systems such as computer servers (or servers in general) or storage servers (also known as “storage appliances”) that have one or more logically-addressed SSDs (laSSDs) has been a challenge. LaSSDs perform table management, such as for logical-to-physical mapping and other types of management, in addition to garbage collection independently of a storage processor in the storage appliance.

When host block associated with an SSD LBA in a stripe is updated/modified, the storage processor initiates a new write to the same SSD LBA. The storage processor also has to modify the parity segment to make sure the parity data for the stripe reflects the changes in the host data. That is, for every segment update in a stripe, the parity data associated with the stripe containing that segment has be read, modified and rewritten to maintain the integrity of the stripe. As such, SSDs associated with the parity segments wear more often than rest of the drives. Furthermore, when one segment contains multiple host blocks, any changes to any of the blocks within the segment will increase overhead associated with GC substantially. Therefore, there is a need for an improved/enhanced method for updating host blocks while minimizing overhead associated with GC and wear of the SSDs containing the parity segments while maintaining the integrity of error recovery. Hence, an optimal and consistent performance is not reached.

### SUMMARY OF THE INVENTION

Briefly, a storage system includes a storage processor coupled to a plurality of solid state disks (SSDs) and a host, the plurality of SSDs being identified by SSD logical block addresses (SLBAs). The storage processor receives a command from the host to write data to the plurality of SSDs, the command from the host accompanied by information used to identify a location within the plurality of SSDs to write the data, the identified location referred to as a host LBA. The storage processor includes a central processor unit (CPU) subsystem and maintains unassigned SLBAs of a corresponding SSD. CPU subsystem upon receiving the command to write data, generates sub-commands based on a range of host LBAs derived from the received command and based on a granularity. At least one of the host LBAs of the host LBAs is non-sequential relative to the remaining host LBAs. Further, the CPU subsystem assigns the sub-commands to unassigned SLBAs by assigning each sub-command to a distinct SSD of a stripe, the host LBAs being decoupled from the SLBAs. The CPU subsystem continues to assign the sub-commands until all remaining SLBAs of the stripe are assigned, after which it calculates parity for the stripe and saves the calculated parity to one or more of the SSDs of the stripe.

These and other features of the invention will no doubt become apparent to those skilled in the art after having read the following detailed description of the various embodiments illustrated in the several figures of the drawing.

### IN THE DRAWINGS

FIG. 1 shows a storage system (or “appliance”), in block diagram form, in accordance with an embodiment of the invention.

FIG. 2 shows, in block diagram form, further details of the CPU subsystem 14, in accordance with an embodiment of the invention. The CPU subsystem 14's CPU is shown to include a multi-core CPU 12.

FIGS. 3a-3c show illustrative embodiments of the contents of the memory 20 of FIGS. 1 and 2.

FIGS. 4a and 4b show flow charts of the relevant steps for a write operation process performed by the CPU subsystem 14, in accordance with embodiments and methods of the invention.

FIG. 5 shows a flow chart of the relevant steps for performing a garbage collection process performed by the CPU subsystem 14, in accordance with methods and embodiments of the invention.

FIG. 6a shows a flow chart of the relevant steps for identifying valid SLBAs in a stripe process performed by the CPU subsystem 14, in accordance with embodiments and methods of the invention.

FIG. 6b-6d show exemplary stripe and segment structures, in accordance with an embodiment of the invention.

FIG. 7 shows an exemplary RAID group m 700, of M RAID groups, in the storage pool 26.

FIG. 8 shows an exemplary embodiment of the invention.

FIG. 9 shows tables 22 of memory subsystem 20 in storage appliance of FIGS. 1 and 2, in accordance with an embodiment of the invention.

FIG. 10a-10c show exemplary L2sL table 330 management, in accordance with an embodiment of the invention.

FIGS. 11a and 11b show examples of a bitmap table 1108 and a metadata table 1120 for each of three stripes, respectively.

### DETAILED DESCRIPTION OF THE EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses of lines are not indicative of actual sizes.

In accordance with an embodiment and method of the invention, a storage system includes one or more logically-addressable solid state disks (laSSDs), with a laSSD including at a minimum, a SSD module controller and flash subsystem.

As used herein, the term “channel” is interchangeable with the term “flash channel” and “flash bus”. As used herein, a “segment” refers to a chunk of data in the flash subsystem of the laSSD that, in an exemplary embodiment, may be made of one or more pages. However, it is understood that other embodiments are contemplated, such as without limitation, one or more blocks and others known to those in the art.

The term “block” as used herein, refers to an erasable unit of data. That is, data that is erased as a unit defines a “block”. In some patent documents and the industry, a “block” refers to a unit of data being transferred to, or received from, a host, as used herein, this type of block may be referenced as “data block”. A “page” as used herein, refers to data that is written as a unit. Data that is written as a unit is herein referred to as “write data unit”. A “dual-page” as used herein, refers to a specific unit of two pages being programmed/read, as known in the industry. A “stripe”, as used herein, is made of a segment from each solid state disk (SSD) of a redundant array of independent disks (RAID) group. A “segment”, as used herein, is made of one or more pages. A “segment” may be a “data segment” or a “parity segment”, with the data segment including data and the parity segment including parity. A “virtual super block”, as used herein, is one or more stripes. As discussed herein, garbage collection is performed on virtual super blocks. Additionally, in some embodiments of the invention, like SSD LBA (SLBA) locations of SSDs are used for stripes to simplify the identification of segments of a stripe. Otherwise, a table needs to be maintained for identifying segments associated with each stripe which would require a large non-volatile memory,

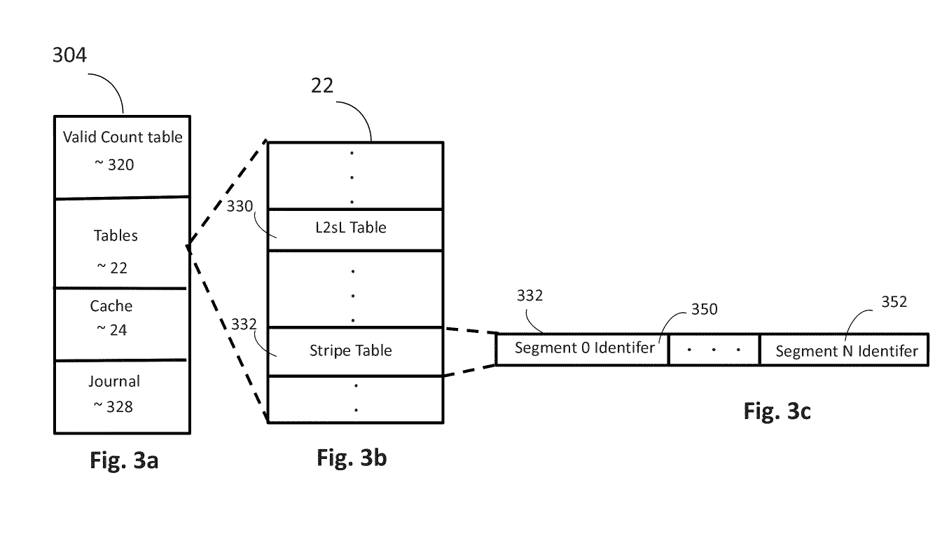

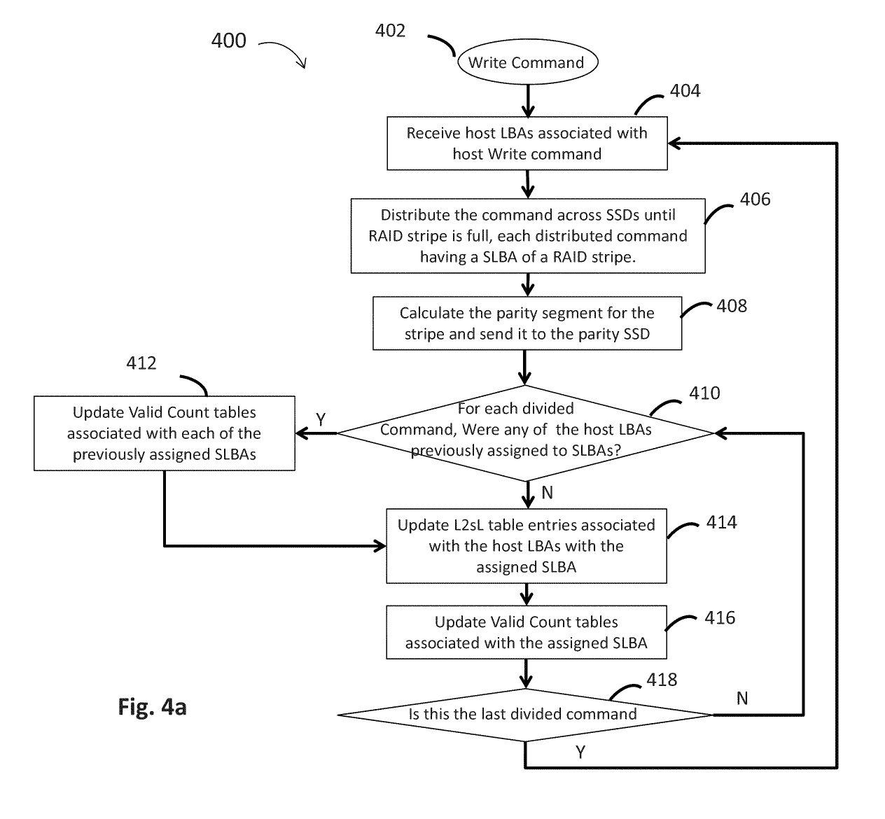

Host commands including data and LBA are broken and data associated with the commands are distributed to segments of a stripe. Storage processor maintains logical association of host LBAs and SSD LBAs (SLBAs) in L2sL table. The storage process further knows the association of the SLBAs and stripes. That is, the storage processor has knowledge of which and how many SLBAs are in each segments of strips. This knowledge is either mathematically derived or maintained in another table such as stripe table 332 in FIG. 3e. The preferred embodiment is the one that is mathematically derived since memory requirement for managing the stripe table 332 is huge and the stripe table has to be maintained in non-volatile memory in case of abrupt power disruption.

Host over-writes are assigned to new SLBAs and as such are written to new segments and hence the previously written data is still in tack and fully accessible by both the storage processor and SSDs. The storage processor updates the L2sL tables with the newly assigned SLBA such that the L2sL table is only pointing to the updated data and uses it for subsequent host reads. The previously assigned SLBAs are marked as invalid by the storage processor but nothing in that effect is reported to the SSDs. SSDs will treat data in the segments associated with the previously assigned SLBAs as valid and doesn't subject them to garbage collections. The data segment associated to previously assigned SLBAs in a stripe are necessary for RAID reconstruction of any of the valid segments in a stripe.

Storage processor performs logical garbage collections periodically to reclaim the previously assigned SLBAs for reuse thereafter. In a preferred embodiment, the storage processor keeps track of invalid SLBAs in a virtual super block and picks virtual super blocks with most number of invalid SLBs as candidates for garbage collection.

Garbage collections moves data segments associated with valid SLBAs of a stripe to another stripe by assigning them to new SLBAs. Parity data need not be moved since upon completion of the logical garbage collection, there are no valid data segments that the parity data had belonged to.
1. Upon completion of logical garbage collection, the entire stripe is no longer holds any valid data and can be reused/recycled into the free stripes for future use. Data associated with stripes undergone garbage collection were either old and invalid or valid and moved to other stripes but SSDs are still unaware of any logical garbage collection is taking place. Once the moves are done, the storage processor sends a command such as SCSI TRIM command to all the SSDs of the stripe to invalidate the SLBAs associated with the segments of the stripe undergone garbage collection. SSDs will periodically perform physical garbage collection and reclaim the physical space associated with the SLBAs. A SCSI TRIM command is typically issued after the process of garbage collection is completed and as a result all SLBAs of stripes that have gone through garbage collection are invalidated. During garbage collection, data associated with valid SLBAs in stripe undergoing garbage collection is moved to another (available) location so that SLBAs in the stripes are no longer pointing to valid data in the laSSDs.

Because host updates and over-write data are assigned to new SLBAs and written to new segments of a stripe and not to previously assigned segments, the RAID reconstruction of the valid segments within the stripe is fully operational.

Each segment of the stripe is typically assigned to one or more SLBAs of SSDs.

Granularity of data associated with SLBAs is typically dependent to the host traffic and size of its input/output (IO) and in range of 4 Kilo Bytes.

A segment is typically one or more pages with each page being one unit of programming of the flash memory devices and in range of 8 to 32 Kilo Bytes.

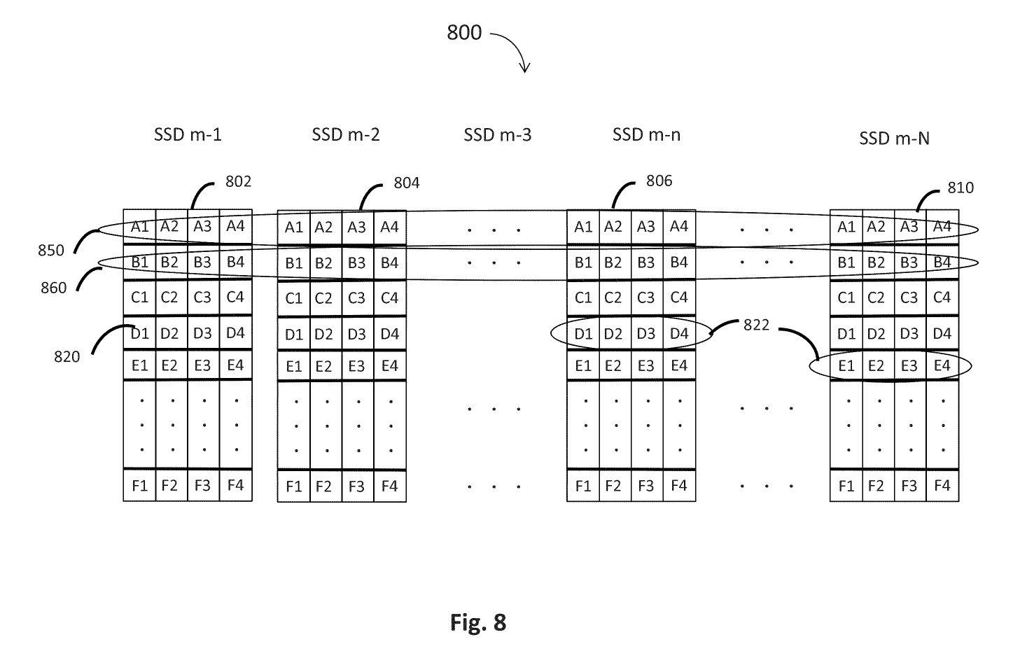

Data associated with one or more SLBAs may reside in a segment. For example, for data IO size of 4K and segment size of 16K, 4 SLBAs are assigned to one segment as shown in FIG. 8.

Embodiment and methods of the invention help reduce the amount of processing required by the storage processor when using laSSDs, as opposed to paSSDs, for garbage collection. Furthermore, the amount of processing by the SSDs is reduced as a part of garbage collection processes of physical SSDs. The storage processor can perform striping across segments of a stripe thereby enabling consistently high performance. The storage processor performs logical garbage collection at a super block level and subsequently issues a command, such as without limitation, a small computer system interface (SCSI)-compliant TRIM command to the laSSDs. This command has the effect of invalidating the SLBAs in the SSDs of the RAID group. That is, upon receiving the TRIM command, in response thereto, the laSSD that is in receipt of the TRIM command carries out an erase operation.

The storage processor defines stripes made of segments of each of the SSDs of a predetermined group of SSDs. Using the storage processor to define striping allows for consistent performance. Additionally, software-defined striping provides for higher performance.

In various embodiments and methods of the invention, the storage processor performs garbage collection to avoid the considerable processing typically required by the laSSDs. Furthermore, the storage processor maintains a table or map of laSSDs and the group of SLBAs that are mapped to logical block addresses of laSSD within an actual storage pool. Such mapping provides a software-defined framework for data striping and garbage collection.

Additionally, in various embodiments of the laSSD, the complexity of a mapping table and garbage collection within the laSSD is significantly reduced in comparison with prior art laSSDs.

The term “virtual” as used herein refers to a non-actual version of a physical structure. For instance, while a SSD is an actual device within a real (actual) storage pool, which is ultimately addressed by physical addresses, laSSD represents an image of a SSD within the storage pool that is addressed by logical rather than physical addresses and that is not an actual drive but rather has the requisite information about a real SSD to mirror (or replicate) the activities within the storage pool.

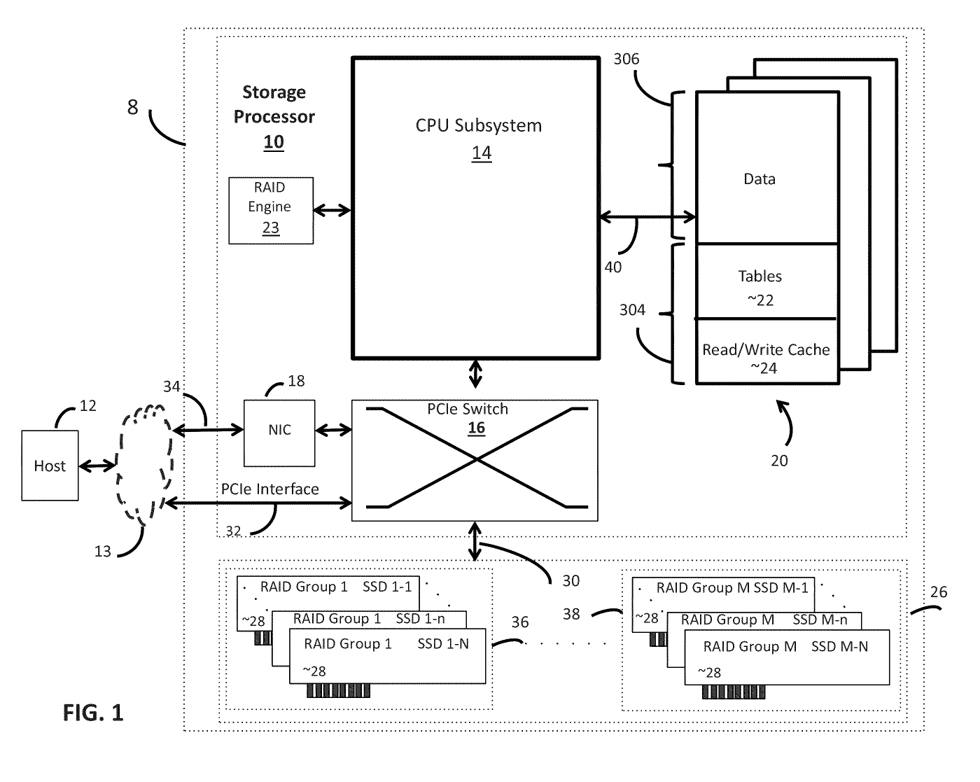

Referring now to FIG. 1, a storage system (or “appliance”) 8 is shown, in block diagram form, in accordance with an embodiment of the invention.

The storage system 8 is shown to include storage processor 10 and a storage pool 26 that are communicatively coupled together.

The storage pool 26 is shown to include banks of solid state drives (SSDs) 28, understanding that the storage pool 26 may have additional SSDs than that which is shown in the embodiment of FIG. 1. A number of SSD groups configured as RAID groups, such as RAID group 1, is shown to include SSD 1-1 through SSD 1-N (‘N’ being an integer value), while the RAID group M (‘M’ being an integer value) is shown made of SSDs M-1 through M-N.). In an embodiment of the invention, the storage pool 26 of the storage system 8 is a Peripheral Component Interconnect Express (PCIe) solid state disks (SSD), herein thereafter referred to as “PCIe SSD”, because it conforms to the PCIe standard, adopted by the industry at large. Industry-standard storage protocols defining a PCIe bus, include non-volatile memory express (NVMe).

The storage system 8 is shown coupled to a host 12 either directly or through a network 13. The storage processor 10 is shown to include a CPU subsystem 14, a PCIe switch 16, a network interface card (NIC) 18, a redundant array of independent disks (RAID) engine 23, and memory 20. The memory 20 is shown to include mapping tables (or “tables”) 22 and a read/write cache 24. Data is stored in volatile memory, such as dynamic random access memory (DRAM) 306, while the read/write cache 24 and tables 22 are stored in non-volatile memory (NVM) 304.

The storage processor 10 is further shown to include an interface 34 and an interface 32. In some embodiments of the invention, the interface 32 is a peripheral component interconnect express (PCIe) interface but could be other types of interface, for example and without limitation, such as serial attached SCSI (SAS), SATA, and universal serial bus (USB).

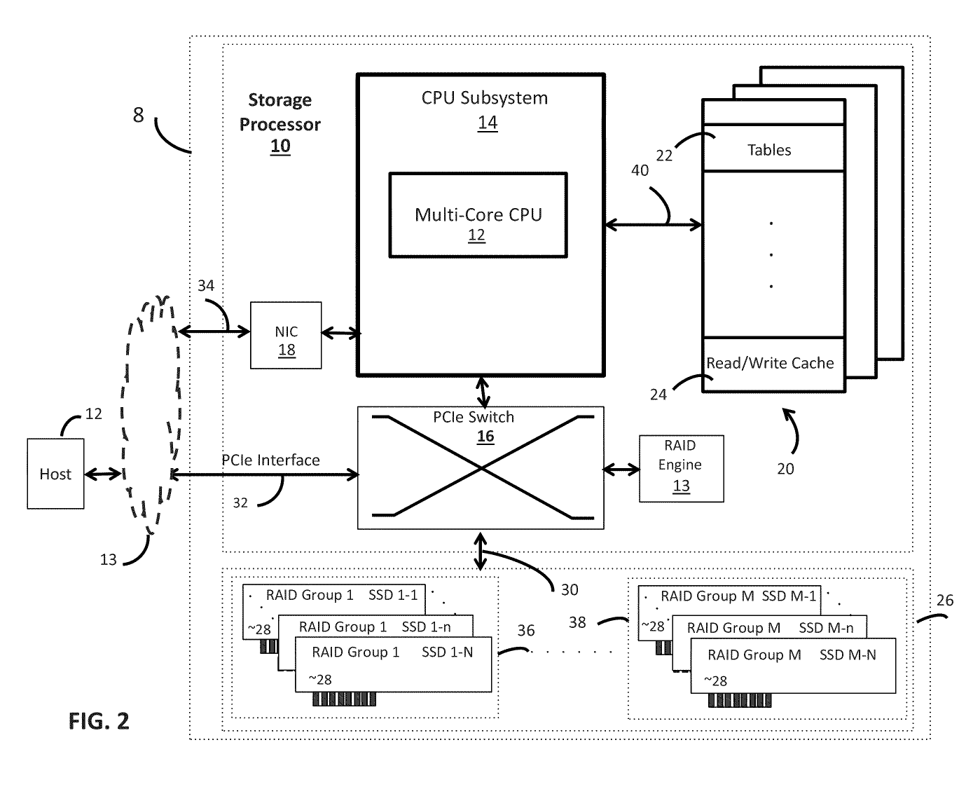

In some embodiments, the CPU subsystem 14 includes a CPU, which may be a multi-core CPU, such as the multi-core CPU 42 of the subsystem 14, shown in FIG. 2. The CPU functions as the brain of the CPU subsystem performs processes or steps in carrying out some of the functions of the various embodiments of the invention in addition to directing them. The CPU subsystem 14 and the storage pool 26 are shown coupled together through PCIe switch 16 via bus 30 in embodiments of the storage processor that are PCIe-Compliant. The CPU subsystem 14 and the memory 20 are shown coupled together through a memory bus 40.

The memory 20 is shown to include information utilized by the CPU sub-system 14, such as the mapping table 22 and read/write cache 24. It is understood that the memory 20 may, and typically does, store additional information, such as data.

The host 12 is shown coupled to the NIC 18 through the network interface 34 and is optionally coupled to the PCIe switch 16 through the interface 32. In an embodiment of the invention, the interfaces 34 and 32 are indirectly coupled to the host 12, through the network 23. An example of a network is the internet (worldwideweb), Ethernet local-area network, or a fiber channel storage-area network.

NIC 18 is shown coupled to the network interface 34 for communicating with host 12 (generally located externally to the processor 10) and to the CPU subsystem 14, through the PCIe switch 16. In some embodiments of the invention, the host 12 is located internally to the processor 10.

The RAID engine 23 is shown coupled to the CPU subsystem 14 and generates parity information of data stripes in a segment and reconstructs data during error recovery.

In an embodiment of the invention, parts or all of the memory 20 are volatile, such as without limitation, DRAM 306. In other embodiments, part or all of the memory 20 is non-volatile, such as and without limitation, flash, magnetic random access memory (MRAM), spin transfer torque magnetic random access memory (STTMRAM), resistive random access memory (RRAM), or phase change memory (PCM). In still other embodiments, the memory 20 is made of both volatile and non-volatile memory, such as DRAM on Dual In Line Module (DIMM) and non-volatile memory on DIMM (NVDIMM), and memory bus 40 is the a DIM interface. The memory 20 is shown to save information utilized by the CPU 14, such as mapping tables 22 and read/write cache 24. Mapping tables 22 is further detailed in FIG. 3b. The read/write cache 24 typically includes more than one cache, such as a read cache and write cache, both of which are utilized by the CPU 14 during reading and writing operations, respectively, for fast access to information. In an embodiment of the invention, mapping tables 22 include a logical to SSD logical (L2sL) table, further discussed below.

In one embodiment, the read/write cache 24 resides in the non-volatile memory of memory 20 and is used for caching write data from the host 12 until host data is written to the storage pool 26.

In embodiments where the mapping tables 22 are saved in the non-volatile memory (NVM 304) of the memory 20, the mapping tables 22 remain intact even when power is not applied to the memory 20. Maintaining information in memory at all times, including power interruptions, is of particular value because the information maintained in the tables 22 is needed for proper operation of the storage system subsequent to a power interruption.

During operation, the host 12 issues a read or a write command. Information from the host is normally transferred between the host 12 and the storage processor 10 through the interfaces 32 and/or 34. For example, information is transferred, through interface 34, between the storage processor 10 and the NIC 18. Information between the host 12 and the PCIe switch 16 is transferred using the interface 34 and under the direction of the of the CPU subsystem 14.

In the case where data is to be stored, i.e. a write operation is consummated, the CPU subsystem 14 receives the write command and accompanying data for storage, from the host, through PCIe switch 16. The received data is first written to write cache 24 and ultimately saved in the storage pool 26. The host write command typically includes a starting LBA and the number of LBAs (sector count) the host intends to write as well as a LUN. The starting LBA in combination with sector count is referred to herein as “host LBAs” or “host-provided LBAs”. The storage processor 10 or the CPU subsystem 14 maps the host-provided LBAs to portion of the storage pool 26.

In the discussions and figures herein, it is understood that the CPU subsystem 14 executes code (or “software program(s)”) to perform the various tasks discussed. It is contemplated that the same may be done using dedicated hardware or other hardware and/or software-related means.

The storage system 8 suitable for various applications, such as without limitation, network attached storage (NAS) or storage attached network (SAN) applications that support many logical unit numbers (LUNs) associated with various users. The users initially create LUNs with different sizes and portions of the storage pool 26 are allocated to each of the LUNs.

In an embodiment of the invention, as further discussed below, the table 22 maintains the mapping of host LBAs to SSD LBAs (SLBAs).

FIG. 2 shows, in block diagram form, further details of the CPU subsystem 14, in accordance with an embodiment of the invention. The CPU subsystem 14's CPU is shown to include a multi-core CPU 12. As with the embodiment of FIG. 1, the switch 16 may include one or more switch devices. In the embodiment of FIG. 2, the RAID engine 13 is shown coupled to the switch 16 rather than the CPU subsystem 14. Similarly, in the embodiment of FIG. 1, the RAID engine 13 may be coupled to the switch 16. In embodiments with the RAID engine 13 coupled to the CPU subsystem 14, clearly, the CPU subsystem 14 has faster access to the RAID engine 13,

The RAID engine 13 generates parity and reconstructs the information read from within an SSD of the storage pool 26.

FIGS. 3a-3c show illustrative embodiments of the contents of the memory 20 of FIGS. 1 and 2. FIG. 3a shows further details of the NVM 304, in accordance with an embodiment of the invention. In FIG. 3a, the NVM 304 is shown to have a valid count table 320, tables 22, cache 24, and journal 328. The valid count table 320 maintains a table of laSSDs that identify logical addresses of laSSDs that hold current data and not old (or “invalid”) data. Journal 328 is a record of modifications to the system that is typically used for failure recovery and is therefore typically saved in non-volatile memory. Valid count table 320 may be maintained in the tables 22 and can be at any granularity, whereas the L2sL table is at a granularity that is based on the size of a stripe, block or super block and also typically depends on garbage collection.

FIG. 3b shows further details of the tables 22, in accordance with an embodiment of the invention. The tables 22 is shown to include a logical-to-SSD-logical (L2sL) tables 330 and a stripe table 332. The L2sL tables 330 are tables maintaining the correspondence between lost logical addresses and SSDs logical addresses. The stripe table 332 is used by the CPU subsystem 14 to identify logical addresses of segments that form a stripe. Stated differently, the stripe table 332 maintains a table of segment addresses with each segment address having logical addresses associated with a single stripe. Using like-location logical addresses from each SSD in a RAID group eliminates the need for the stripe table 332.

Like SLBA locations within SSDs are used for stripes to simplify identification of segments of a stripe. Otherwise, a table needs to be maintained for identifying the segments associated with each stripe, which could require large non-volatile memory space.

FIG. 3c shows further details of the stripe table 332 of tables 22, in accordance with an embodiment of the invention. The stripe table 332 is shown to include a number of segment identifiers, i.e. segment 0 identifier 350 through segment N identifier 352 with “N” representing an integer value. Each of these identifiers identifies a segment logical location within a SSD of the storage pool 26. In an exemplary configuration, the stripe table 332 is indexed by host LBAs to either retrieve or save segment identifier.

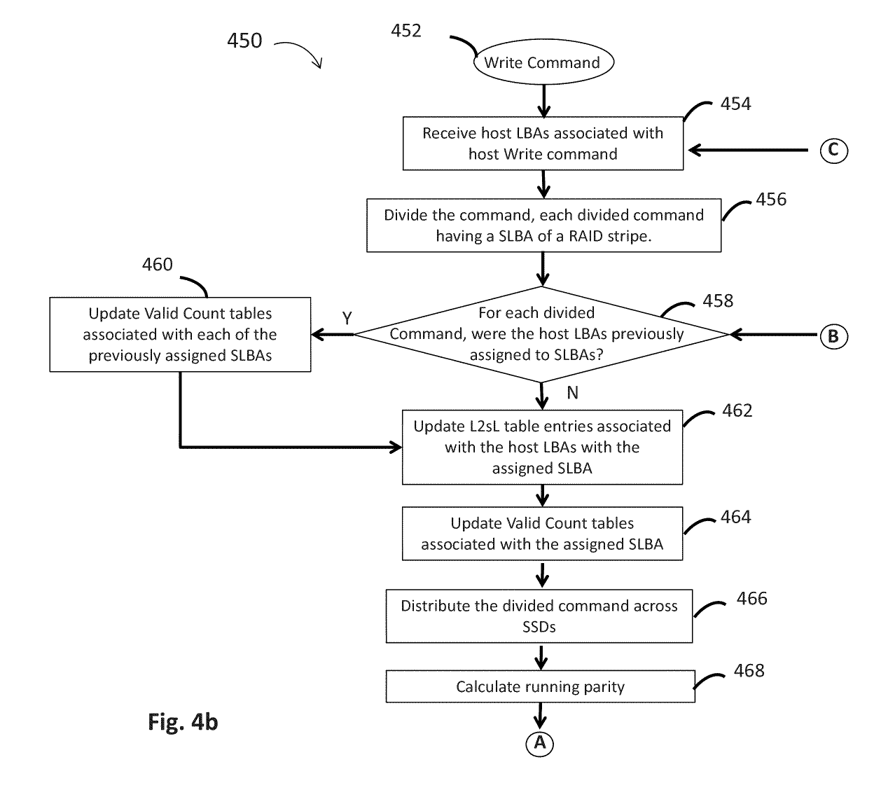

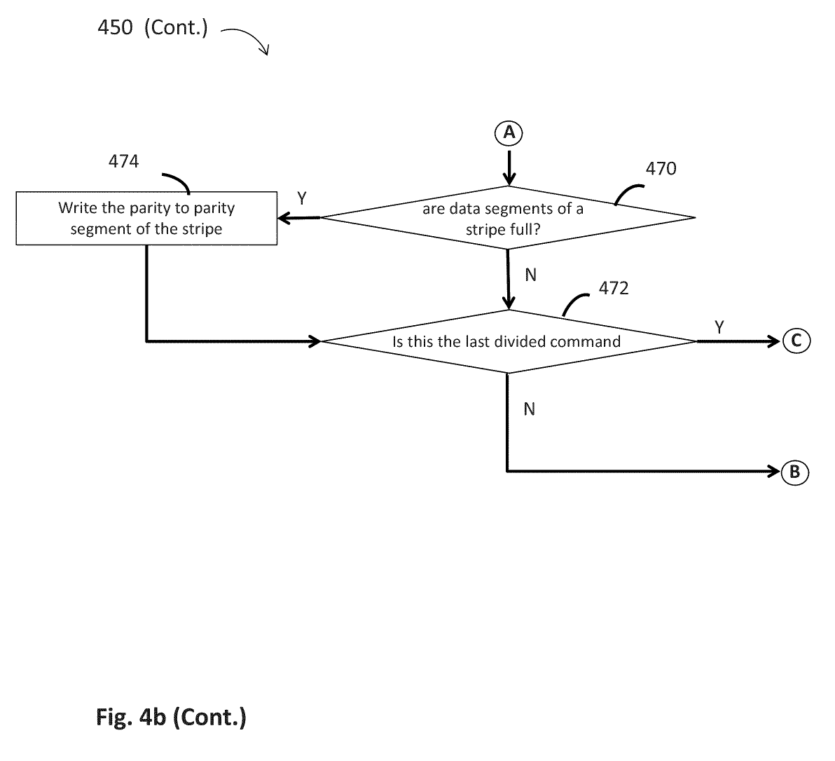

FIG. 4a shows a flow diagram of steps performed by the storage processor 10 during a write operation initiated by the host 12, as it pertains to the various methods and apparatus of the invention. At 402, a write command is received from the host 12 of FIG. 1. As shown at step 404, accompanying the write command are host LBAs and data associated with the write command. Next, at step 406, the write command is distributed across a group of SSDs forming a complete RAID stripe. The group of SSDs is determined by the CPU subsystem 14. The write command is distributed by being divided into a number of sub-commands, again, the number of sub-commands is determined by the CPU subsystem 14. Each distributed command has an associated SLBA of a RAID stripe.

In an embodiment of the invention, the write command is distributed across SSDs until a RAID stripe is complete, and each distributed command includes a SLBA of the RAID stripe

Next, at step 408, a parity segment of the RAID stripe is calculated by the RAID engine 13 and sent to the SSD (within the storage pool 26) of the stripe designated as the parity SSD. Subsequently, at 410, a determination is made for each distributed command as to whether or not any of the host LBAs have been previously assigned to SLBAs. If this determination yields a positive result, the process goes to step 412, otherwise, step 414 is performed.

At step 412, the valid count table 320 (shown in FIG. 3b) is updated for each of the previously-assigned SLBAs and the process continues to step 414. At step 414, the L2sL table 330 (shown in FIG. 3b and as discussed above, maintains the association between the host LBAs and the SLBAs) is updated. Next, at step 416, valid count tables associated with assigned SLBAs are updated. Next, at 418, a determination is made as to whether or not this is the last distributed (or “divided”) command and if so, the process goes to step 404, otherwise, the process goes back to and resumes from 410. It is noted that “valid count table” and “valid count tables”, as used herein, are synonymous. It is understood that a “valid count table” or “valid count tables” may be made of more than one table or memory device.

In an embodiment of the invention, practically any granularity may be used for the valid count table 320, whereas the L2sL table 330 must use a specific granularity that is the same as that used when performing (logical) garbage collection, for example, a stripe, block or super block may be employed as the granularity for the L2sL table.

FIG. 4b shows a flow diagram of steps performed by the storage processor 10 during a write operation, as it pertains to the alternative methods and apparatus of the invention. In FIG. 4b, 452 and step 454 and 458 are analogous to 402 and step 404, and 408 of FIG. 4a, respectively. After step 454, FIG. 4b, and prior to the determination of 458, each write command is divided (or distributed) and has an associated SLBA of a RAID stripe. Viewed differently, a command is broken down into sub-commands and each sub-command is associated with a particular SSD, e.g. SLBA, of stripe, which is made of a number of SSDs. Step 460 is analogous to step 412 of FIGS. 4a and 458 is analogous to 410 of FIG. 4a. Further, steps 462 and 464 are analogous to steps 414 and 416 of FIG. 4a, respectively.

After step 464, in FIG. 4b, step 466 is performed where the divided commands are distributed across to the SSDs of a stripe, similar to that which is done at step 406 of FIG. 4a and next, at step 468, a running parity is calculated. A “running parity” refers to a parity that is being built as its associated stripe is formed. Whereas, a non-running parity is built after its associated stripe is formed. Relevant steps of the latter parity building process are shown in the flow chart of FIG. 4a.

Parity may span one or more segments with each segment residing in a single laSSD. The number of segments forming parity is in general a design choice based on, for example, cost versus reliability, i.e. tolerable error rate and overhead associated with error recovery time. In some embodiments, a single parity segment is employed and in other embodiments, more than one parity segment and therefore more than one parity are employed. For example, RAID 5 uses one parity in one segment whereas RAID 6 uses double parities, each in a distinct parity segment.

It is noted that parity SSD of a stripe, in one embodiment of the invention, is a dedicated SSD, whereas, in other embodiments, the parity SSD may be any of the SSDs of the stripe and therefore not a dedicated parity SSD.

After step 468, a determination is made at 470 as to whether or not all data segments of the stripe being processed store data from the host and if so, the process continues to step 474, otherwise, another determination is made at 472 as to whether or not the command being processed is the last divided command and if so, the process goes onto 454 and resumes from there, otherwise, the process goes to step 458 and resumes from there. At step 474, because the stripe is now complete, the (running) parity is therefore the final parity of the stripe, accordingly, it is written to the parity SSD.

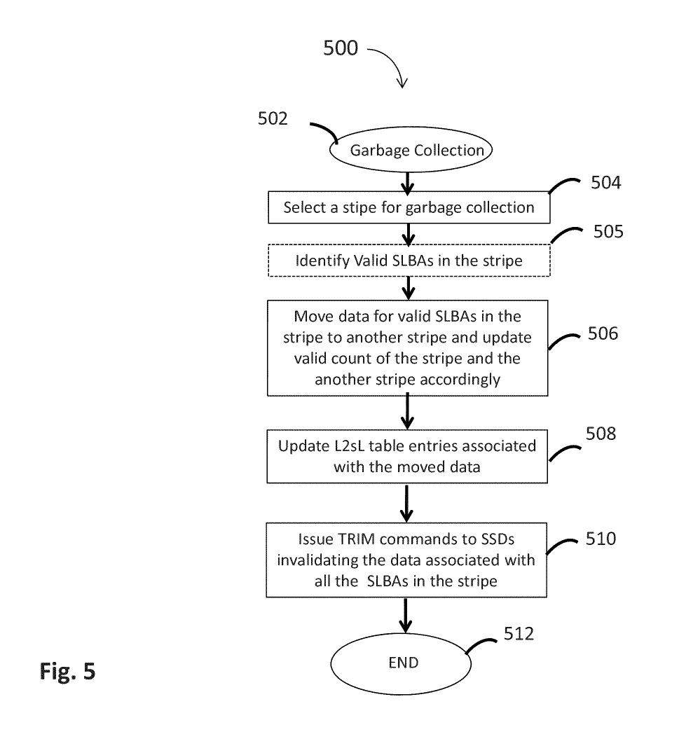

FIG. 5 shows a flow diagram 500 of relevant steps performed by the storage processor when garbage collecting, as it relates to the various methods and embodiments of the invention. At 502, the process of garbage collection begins. At step 504, a stripe is selected for garbage collection based on a predetermined criterion, such as the stripe having an valid count in the table 320 (FIG. 3a). Next, at step 505, valid SLBAs of the stripe are identified. Following step 505, at step 506, data addressed by valid SLBAs of the stripe are moved to another stripe and the valid count of the stripe from which the valid SLBAs are moved as well as the valid count of the stripe to which the SLBAs are moved are updated accordingly.

Next, at step 508, entries of the L2sL table 330 that are associated with the moved data are updated and subsequently, at step 510, data associated with all of the SLBAs of the stripe are invalidated. An exemplary method of invalidating the data of the stripe is to use TRIM commands, issued to the SSDs to invalid the data associated with all of the SLBAs in the stripe. The process ends at 512.

Logical, as opposed to physical, garbage collection is performed. This is an attempt to retrieve all of the SLBAs that are old (lack current data) and no longer logically point to valid data. In an embodiment of the invention when using RAID and parity, SLBAs cannot be reclaimed for at least the following reason. The SLBAs must not be released prematurely otherwise the integrity of parity and error recovery is compromised.

In embodiments avoiding maintaining tables, a stripe has dedicated SLBAs.

During logical garbage collection, the storage processor reads the data associated with valid SLBAa from each logical super block and writes it back with a different SLBA in a different stripe. Once this read-and-write-back operation is completed, there should be no valid SLBAs in the logical super blocks and a TRIM command with appropriate SLBAs is issued to the SSDs of the RAID group, i.e. the RAID group to which the logical super block belongs. Invalidated SLBAs are then garbage collected by the laSSD asynchronously when the laSSD performs its own physical garbage collection. The read and write operations are also logical commands.

In some alternate embodiments and methods, to perform garbage collection (Maryam, who is doing this garbage collection laSSD or the storage appliance?), SLBAs of previously-assigned (“old”) segments are not released unless the stripe to which the SLBAs belong is old. After a stripe becomes old, in some embodiments of the invention, a command is sent to the laSSDs notifying them that garbage collection may be performed.

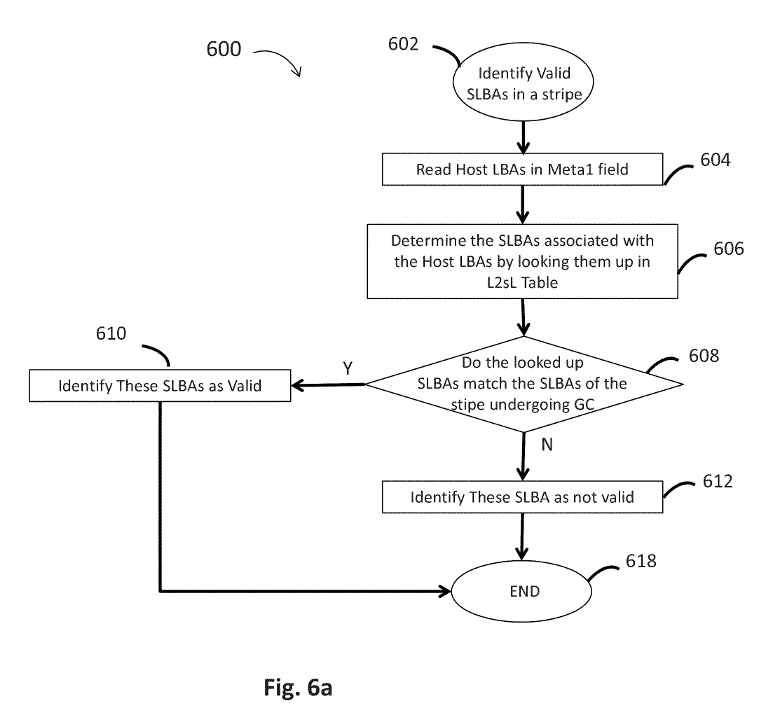

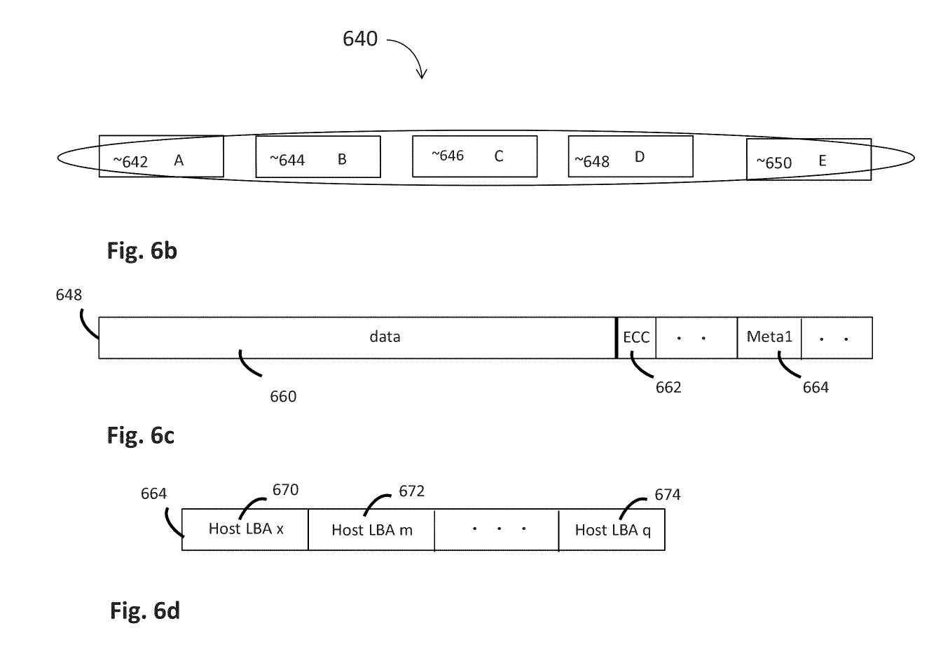

FIG. 6a shows a flow chart 600 of the steps performed by the storage processor 10 when identifying valid SLBAs in a stripe. At 602, the process begins. At step 604, host LBAs are read in a Metal field Meta fields are meta data that is optionally maintained in data segments of stripes. Meta data is typically information about the data, such as the host LBAs associated with a command. Similarly, value counts are kept in one of the SSDs of each stripe.

At step 606, the SLBAs associated with the host LBAs are fetched from the L2sL table 330. Next, at 608, a determination is made as to whether or not the fetched SLBAs match the SLBAs of the stripe undergoing garbage collection and if so, the process goes to step 610, otherwise, the process proceeds to step 612.

At step 610, the fetched SLBAs are identified as being ‘valid’ whereas at step 612, the fetched SLBAs are identified as being ‘invalid’ and after either step 610 or step 612, garbage collection ends at 618. Therefore, ‘valid’ SLBAs point to locations within the SSDs with current, rather than old data, whereas, ‘invalid’ SLBAs point to locations within the SSDs that hold old data.

FIGS. 6b-6d each show an example of the various data structures and configurations discussed herein. For example, FIG. 6b shows an example of a stripe 640, made of segments 642-650 (or A-E). FIG. 6c shows an example of the contents of an exemplary data segment, such as the segment 648, of the stripe 640. The segment 48 is shown to include a data field 660, which holds data originating from the host 12, an error correction coding (ECC) field 662, which holds ECC relating to the data in the data field 660, and a Metal field 664, which holds Meta 1, among perhaps other field not shown in FIG. 6c. ECC of the ECC field 662 is used for the detection and correction of the data of data segment 660. FIG. 6d shows an example of the contents of the Meta 1 field 664, which is shown to be host LBAs x, m, . . . q 670-674.

While not designated in FIGS. 6b-d, one of the segments A-E of the stripe 640 is a parity, rather than a data, stripe and holds the parity that is either a running parity or not, for the stripe 640. Typically, the last segment, i.e. segment E of the stripe 640, is used as the parity segment but as indicated above, any segment may be used to hold parity.

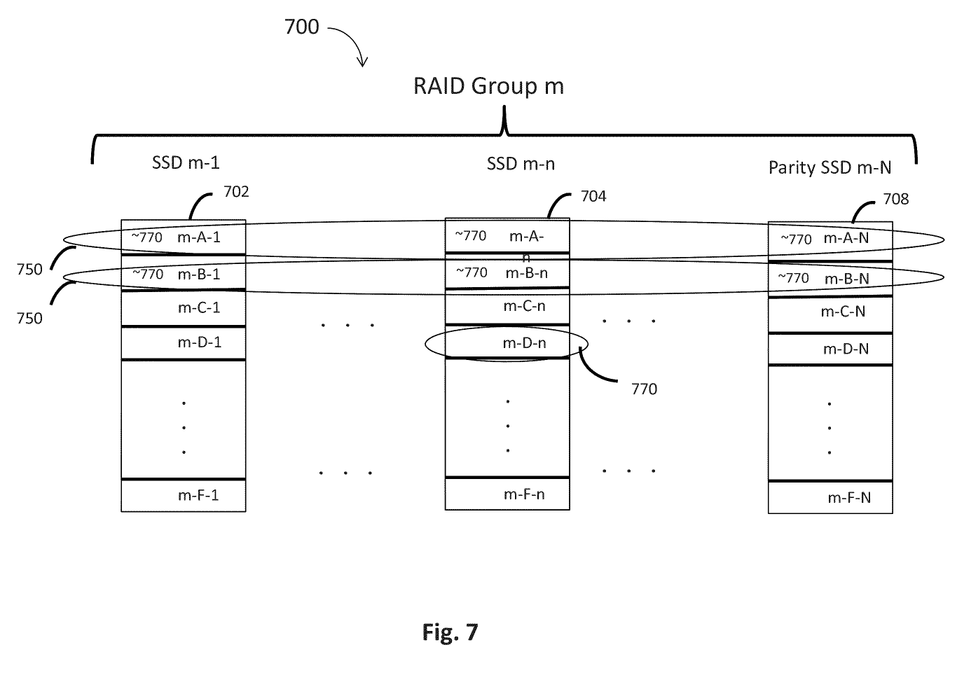

FIG. 7 shows an exemplary RAID group m 700, of M RAID groups, in the storage pool 26, which is shown to comprise SSDs 702 through 708, or SSDm-1 through SSDm-n, where ‘m’ and ‘n’ and ‘M’ are each integer values. SSDs of the storage pool 26 are divided into M RAID groups. Each RAID group m 700, is enumerated 1 through M for the sake of discussion and is shown to include multiple stripes, such as stripe 750. As is well known, a SSD is typically made of flash memory devices. A ‘stripe’ as used herein, includes a number of flash memory devices from each of the SSDs of a RAID group. The number of flash memory devices in each SSD is referred to hereon as a ‘stripe segment’, such as shown in FIG. 7 to be segment 770. At least one of the segments 770 in each of the stripes 750 contains parity information, referred to herein as ‘parity segment’ with the remaining segments in each of the stripes 750 containing host data instead of parity information. A segment that holds host data is herein referred to as a ‘data segment’. Parity segments of stripes 750 may be a dedicated segment within the stripe or a different segment, based on the RAID level being utilized.

In one embodiment of the invention, one or more flash memory pages of host data identified by a single host LBA are allocated to a data segment of a stripe. In another embodiment, each data segment of a stripe may include host data identified by more than one host LBAs. FIG. 7 shows the former embodiment where a single host LBA is assigned to each segment 770. Each host LBA is assigned to a SSD LBA and this relationship is maintained in the L2sL table 330.

FIG. 8 shows an exemplary embodiment of the invention. In FIG. 8, m-N number of SSDs are shown, with ‘m’ and ‘N’ each being an integer. Each of the SSDs 802-810 are shown to include multiple stripes, such as stripes 802, 804, 806, and 810. Each of the segments 802-810 is shown to have four SLBAs, A1-A4 in the SSDs of the stripe 850, B1-B4 in the SSDs of the stripe 860 and so on. An exemplary segment may be 16 kilo bytes (KB) in size and an exemplary host LBA may be 4 KB in size. In the foregoing example, four distinct host LBAs are assigned to a single segment and the relationship between host LBAs and SSD LBAs is maintained in the L2sL table 330. Due to the relationship between the host LBAs and the SSD LBAs (“SLBA”) being that of an assignment in a table, the host LBAs are essentially independent or mutually exclusive of the SSD LBAs.

Optionally, the storage processor 10 issues a segment command to the laSSDs after saving an accumulation of data that is associated with as many SLBAs as it takes to accumulate a segment-size worth of data belonging to these SLBAs, such as A1-A4. The data may be one or more (flash) pages in size. Once enough sub-commands are saved for one laSSD to fill a segment, the CPU subsystem dispatches a single segment command to the laSSD and saves the subsequent sub-commands for the next segment. In some embodiments, the CPU subsystem issues a write command to the laSSD notifying the laSSD to save (or “write”) the accumulated data. In another embodiment, the CPU subsystem saves the write command in a command queue and notifies the laSSD of the queued command.

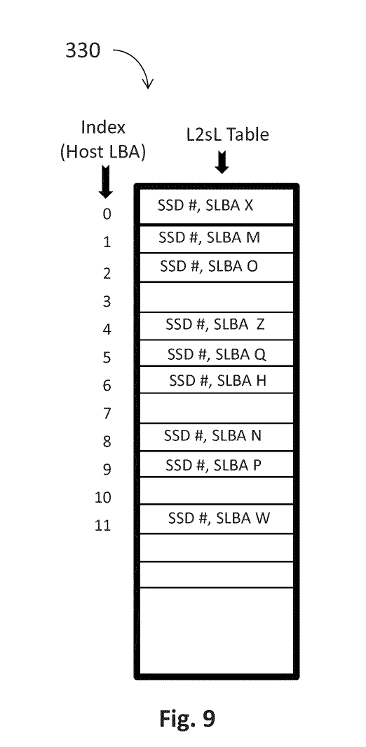

FIG. 9 shows exemplary contents of the L2sL table 330. Each entry of the L2sL table 330 is indexed by a host LBA and includes a SSD number and a SLBA. In this manner, the SLBAs of each row of the table 330 is assigned to a particular host LBA.

While the host LBAs are shown to be sequential, the SSD numbers and the SLBAs are not sequential and rather mutually exclusive of the host LBAs. Accordingly, the host 12 has no idea which SSD is holding which host data. The storage processor performs striping of host write commands, regardless of these commands' LBAs across SSDs a RAID group, by assigning SLBAs of a stripe to LBAs of the host write commands and maintaining this assignment relationship in the L2sL table.

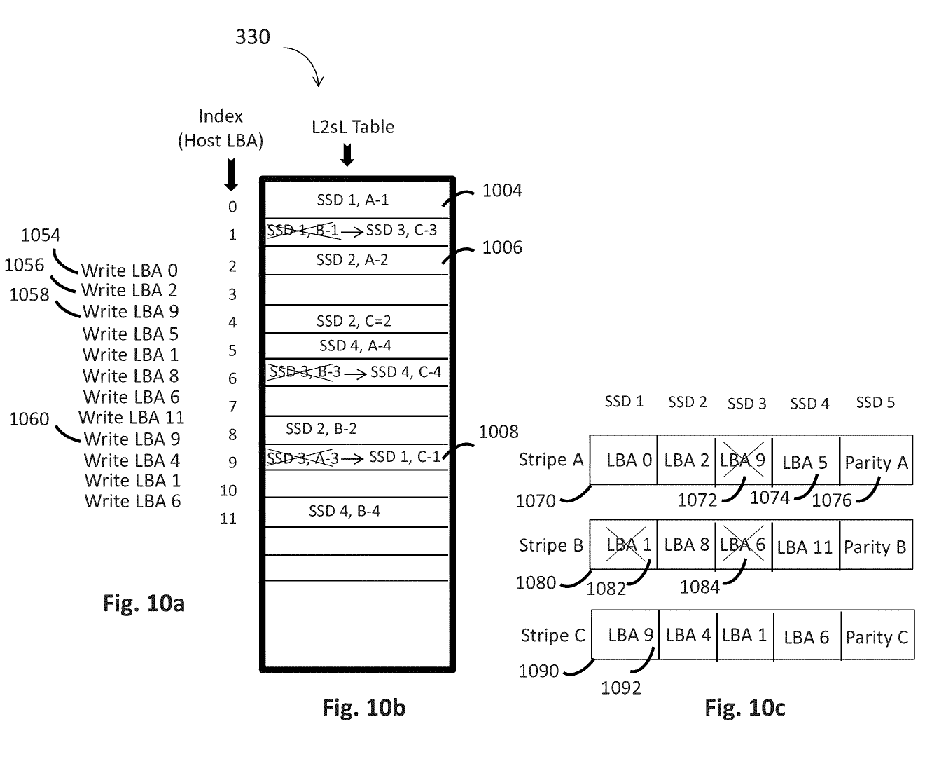

FIGS. 10a-10c show an exemplary L2sL table management scheme. FIG. 10a shows a set of host write commands received by the storage processor 10. The storage processor 10 assigns one or more of the host LBAs associated with a host write command to each of the data segments of a stripe 1070 until all the data segment, such as data segments 1072, 1074, . . . , are assigned after which, the storage processor starts to use another stripe for assigning subsequent host LBAs of the same host write commands assuming unassigned host LBAs remain. In the example of FIGS. 10a-10c, each stripe has 5 segments, 4 of which are data segments and 1 of which is a parity segment. The assignment of segments to host LBAs is one-to-one.

Storage processor 10 assigns “Write LBA 0” command 1054 to a segment A-1 in SSD1 of stripe A 1070, this assignment is maintained at entry 1004 of the L2sL table 330. The L2sL table entry 1004 is associated with the host LBA 0. Storage processor 10 next, assigns a subsequent command, i.e. “Write LBA 2” 1056 command to segment A-2 in SSD 2 of stripe A 1070 and updates the L2sL table entry 1006 accordingly. The storage processor continues the assignment of the commands to the data segments of the stripe A 1070 until all the segments of stripe A are used. The storage processor 10 also computes the parity data for the data segments of stripe A 1070 and writes the computed parity, running parity or not, to the parity segment of stripe A 1070.

The storage processor 10 then starts assigning data segments from stripe B 1080 to the remaining host write commands. In the event a host LBA is updated with new data, the host LBA is assigned to a different segment in the same stripe and the previously-assigned segment is viewed as being invalid. Storage processor 10 tracks the invalid segments and performs logical garbage collection—garbage collection performed on a “logical” rather than a “physical” level—of large segments of data to reclaim the invalid segments. An example of this follows.

In the example of FIG. 10c, the “write LBA 9” 1058 command is assigned to SSD 3, segment A-3. When LBA 9 is updated with the “write LBA 9” 1060, the storage processor assigns a different segment, i.e. SSD 1, segment C-1 of stripe C 990, to the “write LBA 9” 1058 command and updates the L2sL table 330 entry 1008 from SSD3, A-3 to SSD1, C-1 and invalidates segment A-3 1072 in stripe A 1070.

As used herein, “garbage collection” refers to logical garbage collection.

FIG. 10c shows the host LBAs association with the segments of stripes based on the commands listed in FIG. 10a and the assignment of the commands to segments of the stripes are maintained in the L2sL table 330. An “X” across the entries in FIG. 10c, i.e. 1072, 1082, 1084, denotes segments that are previously assigned to host LBAs and subsequently assigned to new segments due to updates. These previously-assigned segments lack the most recent host data and are no longer valid.

Though the host data in a previously-assigned segment of a stripe is no longer current and is rather invalid, it is nevertheless required by the storage processor 10 and the RAID engine 13 to reconstruct the parity of the previously-assigned segment. In the event host data in one of the valid segments of a stripe, such as segment 1074 in stripe A 1070, becomes uncorrectable, i.e. its related ECC cannot correct it, the storage processor can reconstruct the host data using the remaining segments in stripe A 1070 including the invalid host data in segment 1072 and the parity in segment 1076. Since the data for segment 1072 is maintained in the SSD 3, the storage processor 10 has to make sure that SSD 3 does not purge the data associated with the segment 1072 until all data in the data segments of stripe A 1070 are no longer valid. As such, when there is an update to the data in segment 1072, storage processor 10 assigns a new segment 1092 in the yet-to-be-completed stripe C 1090 to be used for the updated data.

During logical garbage collection of stripe A 1070, the storage processor 10 moves all data in the valid data segments of stripe A 1070 to another available stripe. Once a stripe no longer has any valid data, the parity associated with the segment is no longer necessary. Upon completion of the garbage collection, the storage processor 10 sends commands, such as but not limited to SCSI TRIM commands to each of the SSDs of the stripe including the parity segment to invalidate the host data thereof.

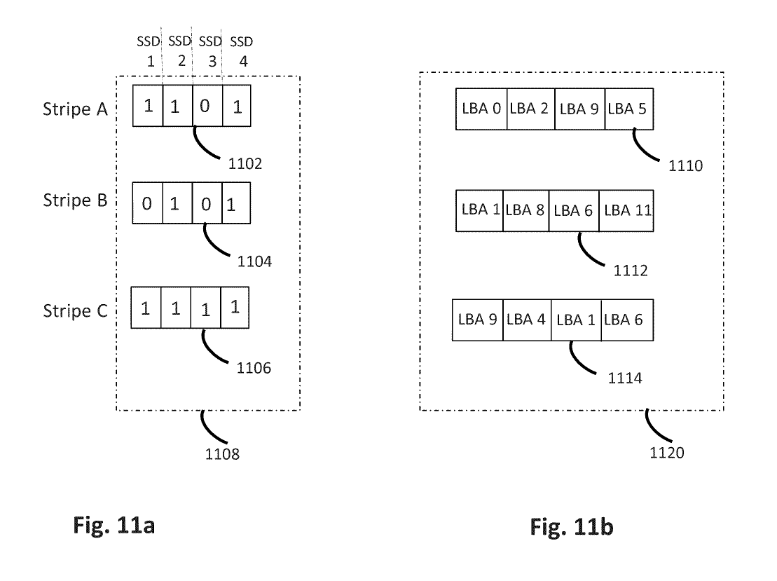

FIGS. 11a and 11b show examples of a bitmap table 1108 and a metadata table 1120 for each of three stripes, respectively. Bit map table 1108 is kept in memory and preferably non-volatile memory. Although in some embodiments, bit map table 1108 is not needed because reconstruction of the bitmap can be done using metal data and the L2sL table as described herein relative to FIG. 6. Using the bitmap 1108 expedites the valid sLBA identification process but requires a bit for every SLBA that could consume large memory space. As earlier noted with reference to FIGS. 6b and 6c, the metadata table 1120 is maintained in a segment, such as the data segment 648 of FIGS. 6b-6d.

The table 1108 is shown to include a bitmap for each stripe. For instance, bitmap 1102 is for stripe A, bitmap 1004 is for stripe b, and bitmap 1106 is for stripe C. While a different notation may be used, in an exemplary embodiment, a value of ‘1’ in the bitmap table 1108 signifies a valid segment and a value of “0” signifies an invalid segment. The bitmaps 1102, 1104 and 1106 are consistent with the example of FIGS. 10a-10c. Bitmap 1102 identifies the LBA9 in stripe A as being invalid. In one embodiment, the storage processor 10 uses the bitmap of each stripe to identify the valid segments of the stripe. In another embodiment of the invention, the storage processor 10 identifies stripes with the highest number of invalid bits in the bitmap table 1108 as candidates for the logical garbage collection.

Bitmap table management can be time intensive and consumes significantly-large non-volatile memory. Thus, in another embodiment of the invention, only a count of valid SLBA for each logical super block is maintained to identify the best super block candidates for undergoing logical garbage collection.

Metadata table 1120 for each stripe A, B, and C, shown in FIG. 11b, maintains all of the host LBAs for each corresponding stripe. For example, metadata 1110 holds the host LBAs for stripe A, with the metadata being LBA0, LBA2, LBA9, and LBA5.

In one embodiment of the invention, the metadata 1120 is maintained in the non-volatile portion 304 of the memory 20.

In another embodiment of the invention, the metadata 1120 is maintained in the same stripe as its data segments.

In summary, an embodiment and method of the invention includes a storage system that has a storage processor coupled to a number of SSDs and a host. The SSDs are identified by SSD LBAs (SLBAs). The storage processor receives a write command from the host to write to the SSDs, the command from the host is accompanied by information used to identify a location within the SSDs to write the host data. The identified location is referred to as a “host LBA”. It is understood that host LBA may include more than one LBA location within the SSDs.

The storage processor has a CPU subsystem and maintains unassigned SSD LBAs of a corresponding SSD. The CPU subsystem, upon receiving commands from the host to write data, generates sub-commands based on a range of host LBAs that are derived from the received commands using a granularity. At least one of the host LBAs of the range of host LBAs is non-sequential relative to the remaining host LBAs of the range of host LBAs.

The CPU subsystem then maps (or “assigns”) the sub-commands to unassigned SSD LBAs with each sub-command being mapped to a distinct SSD of a stripe. The host LBAs are decoupled from the SLBAs. The CPU subsystem repeats the mapping step for the remaining SSD LBAs of the stripe until all of the SSD LBAs of the stripe are mapped, after which the CPU subsystem calculates the parity of the stripe and saves the calculated parity to one or more of the laSSDs of the stripe. In some embodiments, rather than calculating the parity after a stripe is complete, a running parity is maintained.

In some embodiments, parity is saved in a fixed location, i.e. a permanently-designated parity segment location. Alternatively, the parity's location alters between the laSSDs of its corresponding stripe. The storage system, as recited in claim 1, wherein data is saved in data segments and the parity is saved in parity segments in the laSSDs. In an embodiment of the embodiment, a segment is accumulated worth of sub-commands, the storage processor issuing a segment command to the laSSDs.

Upon accumulation of a segment worth of sub-commands, the storage processor issues a segment command to the laSSDs. Alternatively, upon accumulating a stripe worth of sub-commands and calculating the parity, segment commands are sent to all the laSSDs of the stripe.

In some embodiments, the stripe includes valid and invalid SLBAs and upon re-writing of all valid SLBAs to the laSSD, and the SLBAs of the stripe that are being re-written are invalid, a command is issued to the laSSDs to invalidate all SLBAs of the stripe. This command may be a SCSCI TRIM command. SLBAs associated with invalid data segments of the stripe are communicated to the laSSDs.

In accordance with an embodiment of the invention, for each divided command, the CPU subsystem determines whether or not any of the associated host LBAs have been previously assigned to the SLBAs. The valid count table associate with assigned SLBAs is updated.

In some embodiments of the invention, the unit of granularity is a stripe, block or super block.

In some embodiments, logical garbage collection using a unit of granularity that is a super block granularity. Performing garbage collection at the super block granularity level allows the storage system to enjoy having to perform maintenance as frequently as it would in cases where the granularity for garbage collection is at the block or segment level. Performing garbage collection at a stripe level is inefficient because the storage processor manages the SLBAs at a logical super block level.

Although the present invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

1. A storage system comprising:
a storage processor coupled to a plurality of solid state disks (SSDs) and a host, the plurality of SSDs being identified by SSD logical block addresses (SLBAs), the storage processor responsive to a command from the host to write to the plurality of SSDs, the command from the host accompanied by information used to identify a location within the plurality of SSDs to write data, the identified location referred to as a host LBA, the storage processor including a central processor unit (CPU) subsystem and maintaining unassigned SLBAs of a corresponding SSD, a, the CPU subsystem being operable to:
upon receiving a command to write data, generate sub-commands based on a range of host LBAs derived from the received command based on a granularity, at least one of the host LBAs of the host LBAs being non-sequential relative to the remaining host LBAs,
assign the sub-commands to unassigned SLBAs wherein each sub-command is assigned to a distinct SSD of a stripe, the host LBAs being decoupled from the SLBAs,
continue to assign the sub-commands until all remaining SLBAs of the stripe are assigned,
calculate parity for the stripe; and
save the calculated parity to one or more of the SSDs of the stripe.

2. The storage system, as recited in claim 1, wherein the location of the saved parity in the stripe is fixed.

3. The storage system, as recited in claim 1, wherein the location of the saved parity alters between the laSSDs of the stripe.

4. The storage system, as recited in claim 1, wherein data is saved in the host data segments and the parity is saved in parity segments in the SSDs.

5. The storage system, as recited in claim 1, wherein upon accumulating a segment worth of sub-commands, the storage processor issuing a segment command to the SSDs.

6. The storage system, as recited in claim 1, wherein upon accumulating a segment worth of sub-commands, the storage processor issuing a segment command to the SSDs.

7. The storage system, as recited in claim 1, wherein upon accumulating a stripe worth of sub-commands and calculating the parity, sending segment commands to all the SSDs of the stripe.

8. The storage system, as recited in claim 1, wherein the stripe include valid and invalid SLBAs and upon re-writing of all valid SLBAs to the laSSD, and the SLBAs of the stripe being re-written being invalid, issuing a particular command to the laSSDs to invalidate all SLBAs of the stripe.

9. The storage system, as recited in claim 8, wherein the particular command is a SCSCI TRIM command.

10. The storage system, as recited in claim 1, wherein communicating the SLBAs of the invalid data segments of the stripe to the SSDs.

11. The storage system, as recited in claim 1, wherein for each divided command, the CPU subsystem determining whether or not any of the host LBAs are previously assigned to the SLBAs.

12. The storage system, as recited in claim 1, further including updating a valid count table associate with the assigned SLBAs.

13. The storage system, as recited in claim 1, wherein the unit of granularity is a stripe, block or super block.

14. The storage system, as recited in claim 1, wherein the SSDs are logically-addressable SSDs.

15. A storage system comprising:
a storage processor coupled to a plurality of solid state disks (SSDs) and a host, the plurality of SSDs being identified by SSD logical block addresses (SLBAs), the storage processor responsive to a command from the host to write data to the plurality of SSDs, the command from the host accompanied by information used to identify a location within the plurality of SSDs to write the data, the identified location referred to as a host LBA, the storage processor including a central processor unit (CPU) subsystem and maintaining unassigned SSD LBAs of a corresponding SSD, the CPU subsystem being operable to:
upon receiving a command to write data, generate sub-commands based on a range of host LBAs derived from the received commands and a granularity, at least one of the host LBAs of the range of host LBAs being non-sequential relative to the remaining host LBAs of the range of host LBAs,
assign the sub-commands to unassigned SLBAs wherein each sub-command is assigned to a distinct SSD of a stripe, the host LBAs being decoupled from the SLBAs;
calculate a running parity of the stripe;
upon completion of assigning the sub-commands to the stripe, save the calculated parity to one or more of the SSDs of the stripe; and
continue to assign until the sub-commands are assigned to remaining SLBAs of the stripe.

16. The storage system of claim 15, further including after sending the last data segment to the laSSD.

17. The storage system of claim 15, further including after sending the last data segment to the SSD, sending the result of the last running parity to the parity SSD.

18. A method of employing a storage system comprising:
receiving a command from the host to write data to a plurality of SSDs, the command from the host accompanied by information used to identify a location within the plurality of SSDs to write the data, the identified location referred to as a host LBA, the plurality of SSDs being identified by SSD logical block addresses (SSD LBAs), the storage processor including a central processor unit (CPU) subsystem and maintaining unassigned SSD LBAs of a corresponding SSD;
upon receiving the command to write data, the CPU subsystem generating sub-commands based on a range of host LBAs derived from the received commands and a granularity, at least one of the host LBAs of the range of host LBAs being non-sequential relative to the remaining host LBAs of the range of host LBAs;
mapping the sub-commands to unassigned SSD LBAs wherein each sub-command is mapped to a distinct SSD of a stripe, the host LBAs being decoupled from the SSD LBAs (SLBAs);
repeating the mapping step for remaining SSD LBAs of the stripe until all of the SSD LBAs of the stripe are mapped,
calculating parity for the stripe; and
saving the calculated parity to one or more of the SSDs of the stripe.

19. The method of claim 18, further including altering the location of the saved parity between the SSDs of the stripe.

20. The method of claim 18, further including saving the host data in data segments of the SSDs and saving the parity in parity segments of the SSDs.

21. The method of claim 18, further including selecting a unit of granularity for garbage collection.

22. The method of claim 21, further including identifying valid data segments in the unit of granularity.

23. The method of claim 21, further including moving the identified data segments to another stripe, wherein the unit of granularity becomes an invalid unit of granularity.
